(19) United States
(12) Patent Application Publication
(10) Pub. No.: US 2023/0381925 A1
(43) Pub. Date: Nov. 30, 2023

(54) RESTRAINT AND STOWAGE DEVICE AND METHODS OF USE THEREOF

(71) Applicant: Robert Joseph Kuruc, JR., Vandergrift, PA (US)

(72) Inventor: Robert Joseph Kuruc, JR., Vandergrift, PA (US)

(21) Appl. No.: 17/664,966

(22) Filed: May 25, 2022

(51) Int. Cl. B25B 5/10; B25B 5/02; B25B 5/16

(52) U.S. Cl. CPC B25B 5/102; B25B 5/02; B25B 5/163

(57) ABSTRACT

Embodiments relate to a restraint and stowage device comprising a fixed jaw and a movable jaw, wherein the fixed jaw is attached to an elongated rod. The elongated rod may be receivable through an aperture of the movable jaw. The movable jaw is positioned along the elongated rod such that an object may be securely restrained between the movable jaw, the fixed jaw, and the elongated rod. The position of the movable jaw may be fixed by an end piece.

### FIELD OF THE INVENTION

Embodiments relate to a restraint and stowage device generally and methods of use thereof. More particularly, embodiments relate to a restraint and stowage device for tree stands and other large objects and methods of use thereof.

### BACKGROUND OF THE INVENTION

Tree stands have long been used to hunt and observe wildlife from an advantageously elevated position. However, tree stands, like many other large objects, are often difficult to stow and transport due to their size and lack of easy-to-use, efficient restraining methods. Accordingly, there is a clear need for a device to be used with large objects, particularly tree stands, to allow for easy and efficient restraint and stowage.

### SUMMARY OF THE INVENTION

Embodiments relate to a restraint and stowage device that may be used to restrain and stow objects, particularly large objects (e.g., tree stands, ladders, or any other suitable objects), that may not otherwise be easily restrained and stowed. A restraint and stowage device comprises a fixed jaw and a movable jaw, wherein the fixed jaw is attached to an elongated rod. The elongated rod may be receivable through an aperture of the movable jaw. The movable jaw is positioned along the elongated rod such that an object may be securely restrained between the movable jaw, the fixed jaw, and the elongated rod. The position of the movable jaw may be fixed by an end piece.

An exemplary embodiment relates to a restraint and stowage device. The device can include a fixed jaw. The device can include an elongated rod attached to the fixed jaw. The device can include a movable jaw comprising an aperture, wherein the elongated rod is receivable through the aperture and wherein the movable jaw is configured to move about the elongated rod. The device can include an end piece comprising a bore, wherein the elongated rod is receivable through the bore.

In some embodiments, the end piece is configured to maintain a position of the movable jaw.

In some embodiments, the movable jaw and the fixed jaw are configured to jointly engage an object to be restrained.

In some embodiments, the elongated rod has an external thread.

In some embodiments, the bore has an internal thread and wherein the internal thread is configured to complement the external thread of the elongated rod.

In some embodiments, the aperture has an internal thread, wherein the internal thread is configured to complement the external thread of the elongated rod.

In some embodiments, the end piece comprises a securing means.

In some embodiments, the end piece comprises a handle.

In some embodiments, the elongated rod and the fixed jaw are a single molded piece.

In some embodiments, the fixed jaw comprises a first portion and a second portion, wherein the first portion and the second portion are configured to jointly engage an object to be restrained.

In some embodiments, the first portion of the fixed jaw and the second portion of the fixed jaw form an elbow.

In some embodiments, the movable jaw comprises a first portion and a second portion, wherein the first portion and the second portion are configured to jointly engage an object to be restrained.

In some embodiments, the first portion of the movable jaw and the second portion of the movable jaw form an elbow.

An exemplary embodiment relates to a restraint and stowage device. The device can include a fixed jaw comprising a first portion and a second portion, wherein the first portion of the fixed jaw and the second portion of the fixed jaw are configured to jointly engage an object to be restrained. The device can include an elongated rod attached to the first portion of the fixed jaw. The device can include a movable jaw comprising a first portion and a second portion, wherein the first portion of the movable jaw and the second portion of the movable jaw are configured to jointly engage an object to be restrained. The device can include an aperture positioned within the first portion of the movable jaw, wherein the elongated rod is receivable through the aperture and wherein the movable jaw is configured to move about the elongated rod. The device can include an end piece comprising a bore, wherein the elongated rod is receivable through the bore and wherein the end piece is configured to maintain a position of the movable jaw.

An exemplary embodiment relates to a method of using an embodiment of a restraint and stowage device. The method can involve positioning the fixed jaw and the elongated rod such that an object is contacted by the fixed jaw. The method can involve receiving the elongated rod through the aperture of the movable jaw. The method can involve positioning the movable jaw such that the object is contacted by the movable jaw. The method can involve receiving the elongated rod through the bore of the end piece. The method can involve positioning the end piece in contact with the movable jaw.

In some embodiments, the method involves fixing the position of the end piece such that the position of the movable jaw is maintained.

In some embodiments, the elongated rod has an external thread and the bore has an internal thread configured to complement the external thread of the elongated rod, and the method involves fixing the position of the end piece such that the position of the movable jaw is maintained by rotating the end piece.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1A is a top view of an embodiment of a restraint and stowage device.

FIG. 1B is a top view of an embodiment of a restraint and stowage device.

FIG. 1C is a top view of an embodiment of a restraint and stowage device.

FIG. 2 is a side view of an embodiment of a movable jaw of a restraint and stowage device.

FIG. 3 is a bottom view of an embodiment of an end piece of a restraint and stowage device.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

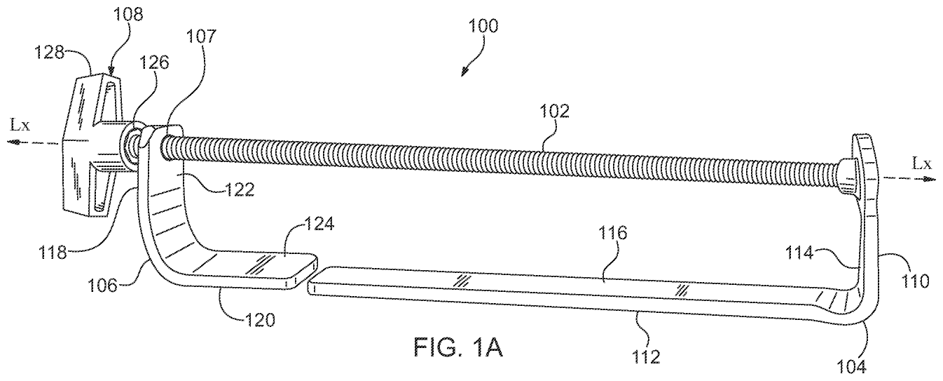

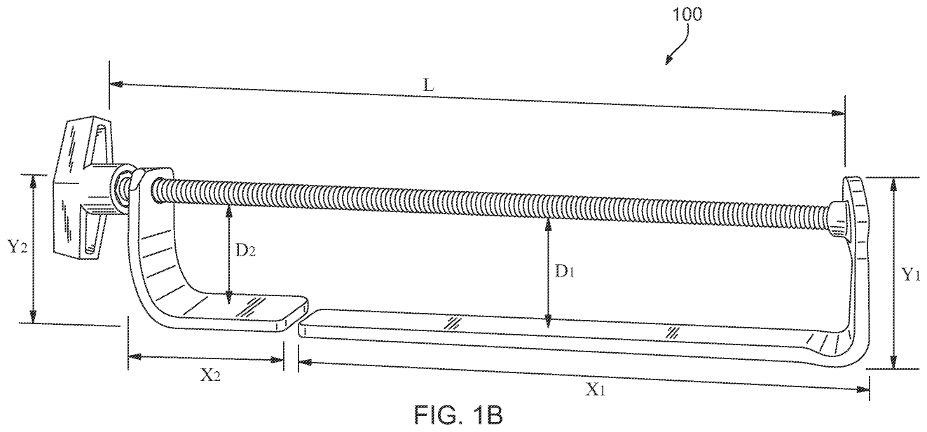

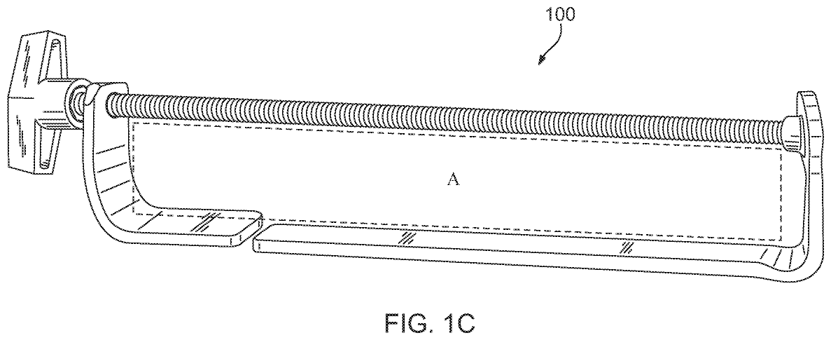

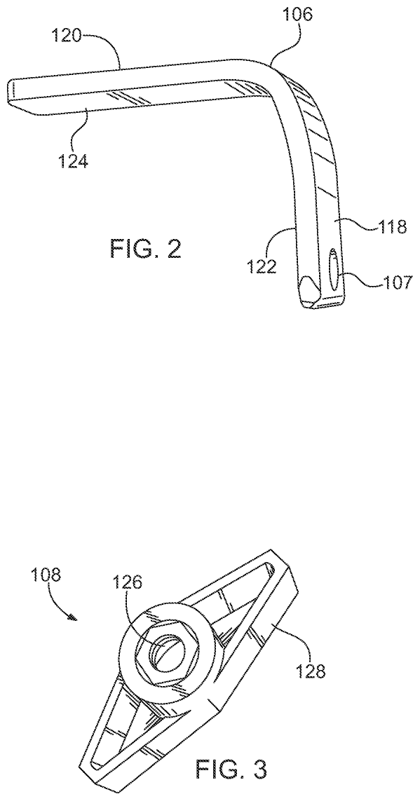

As seen in FIGS. 1A and 1B, a device 100 comprises an elongated rod 102, a fixed jaw 104, and a movable jaw 106, wherein the fixed jaw 104 is attached to the elongated rod 102. The elongated rod 102 may be receivable through an aperture 107 of the movable jaw 106. The movable jaw 106 may be positioned along the elongated rod 102 such that an object may be securely restrained between the movable jaw 106, the fixed jaw 104, and the elongated rod 102. The position of the movable jaw 106 may be fixed by an end piece 108.

The elongated rod 102 may extend along a longitudinal axis Lx and have a length L. The elongated rod 102 may be in the form of any shape, but it is contemplated that the elongated rod 102 is circular cylindrical. The elongated rod 102 may be made from a rigid material (e.g., metal, plastic, or any other suitable material).

The fixed jaw 104 may be in the form of any shape, such as rectangular, “C” shaped, “L” shaped, or any other suitable shape, but it is contemplated that the fixed jaw 104 comprises a first portion 110 and a second portion 112. The first portion 110 may be configured to be perpendicular to or substantially perpendicular to the second portion 112, such that the first portion 110 and the second portion 112 may form an elbow. It is contemplated that the elbow may not form a perfectly square and/or sharp angle, and the elbow may instead form an imperfect and/or rounded angle.

The first portion 110 may have length Y₁, and the second portion 112 may have length X₁. The first portion 110 may comprise an engagement surface 114 configured to engage the object(s) to be restrained and/or stowed. It is contemplated that the engagement surface 114 may be flat or substantially flat. The second portion 112 may comprise an engagement surface 116 configured to engage the object(s) to be restrained and/or stowed. It is contemplated that the engagement surface 116 may be flat or substantially flat.

The elongated rod 102 may be fixed to the first portion 110 of the fixed jaw 104, wherein the elongated rod 102 is positioned opposite of the elbow formed by the first portion 110 and the second portion 112. The elongated rod 102 may further be positioned such that the elongated rod 102 and the second portion 112 extend in the same direction and are parallel or substantially parallel to one another. For instance, the elongated rod 102 may be perpendicular to or substantially perpendicular to the first portion 110 of the fixed jaw 104. It is contemplated that a gap of distance D₁ may be formed between the elongated rod 102 and the second portion 112 of the fixed jaw 104. The distance D₁ is directly proportional to the length Y₁ of the first portion 110. It is contemplated that the distance D₁ defines the maximum width of the load to be restrained and/or towed with respect to the fixed jaw 104.

It is contemplated that the fixed jaw 104 may be made from a rigid material (e.g., metal, plastic, or any other suitable material).

It is contemplated that the elongated rod 102 and the fixed jaw 104 may be a single molded piece.

As seen in FIGS. 1A and 3, the movable jaw 106 may be in the form of any shape, such as rectangular, “C” shaped, “L” shaped, or any other suitable shape, but it is contemplated that the movable jaw 106 comprises a first portion 118 and a second portion 120. The first portion 118 may be configured to be perpendicular to or substantially perpendicular to the second portion 120, such that the first portion 118 and the second portion 120 may form an elbow. It is contemplated that the elbow may not form a perfectly square and/or sharp angle, and the elbow may instead form an imperfect and/or rounded angle.

It is contemplated that the fixed jaw 104 and the movable jaw 106 may not be in the form of the same shape.

The first portion 118 may have length Y₂, and the second portion 120 may have length X₂. The first portion 118 may comprise an engagement surface 122 configured to engage the object(s) to be restrained and/or stowed. It is contemplated that the engagement surface 122 may be flat or substantially flat. The second portion 120 may comprise an engagement surface 124 configured to engage the object(s) to be restrained and/or stowed. It is contemplated that the engagement surface 124 may be flat or substantially flat.

The first portion 118 of the movable jaw 106 may comprise an aperture 107. The aperture 107 may be positioned opposite of the elbow formed by the first portion 118 and the second portion 120. The aperture 107 may complement a cross-sectional shape of the elongated rod 102, such that the elongated rod 102 may be receivable through aperture 107 and the movable jaw 106 may be movable along axis Lx of the elongated rod 102. For instance, the movable jaw 106 may be moved freely, inwardly, and outwardly along axis Lx of the elongated rod 102. The ability of the movable jaw 106 to move along axis Lx of elongated rod 102 allows a user to adjust the device 100 to complement the actual length of the load to be restrained and/or towed such that the load is fully engaged by both the fixed jaw 104 and the movable jaw 106.

It is contemplated that the shape and size of the aperture 107 may be larger than the cross-sectional shape and size of the elongated rod 102. For instance, the moveable jaw 106 may be free to pivot slightly around elongated rod 102, as the aperture 107 may be larger than the elongated rod 102. The movable jaw 106 may further be rotatable about axis Lx of the elongated rod 102.

As the elongated rod 102 is received through the aperture 107, the elongated rod 102 is positioned opposite of the elbow formed by the first portion 118 and the second portion 120, such that the elongated rod 102 and the second portion 120 are parallel or substantially parallel to one another. It is contemplated that a gap of distance D₂ may be formed between the elongated rod 102 and the second portion 120 of the movable jaw 106. The distance D₂ is directly proportional to the length Y₂ of the first portion 118. It is contemplated that the distance D₂ defines the maximum width of the load to be restrained and/or towed with respect to the movable jaw 106.

In an exemplary embodiment, the length Y₁ of the first portion 110 of the fixed jaw 104 may be equal to or substantially equal to the length Y₂ of the first portion 122 of the movable jaw 106. In this embodiment, distance D₁ is equal to or substantially equal to distance D₂.

In an exemplary embodiment, the length Y₁ of the first portion 110 of the fixed jaw 104 may be greater than the length Y₂ of the first portion 122 of the movable jaw 106. In this embodiment, distance D₁ is greater than distance D₂.

In an exemplary embodiment, the length Y₁ of the first portion 110 of the fixed jaw 104 may be less than the length Y₂ of the first portion 122 of the movable jaw 106. In this embodiment, distance D₁ is less than distance D₂.

In an exemplary embodiment, the length X₁ of the second portion 112 of the fixed jaw 104 may be equal to the length X₂ of the second portion 120 of the movable jaw 106.

In an exemplary embodiment, the length X₁ of the second portion 112 of the fixed jaw 104 may be greater than the length X₂ of the second portion 120 of the movable jaw 106.

In an exemplary embodiment, the length X₁ of the second portion 112 of the fixed jaw 104 may be less than the length X₂ of the second portion 120 of the movable jaw 106.

It is contemplated that the sum of the length X₁ of the second portion 112 of the fixed jaw 104 and the length X₂ of the second portion 120 of the movable jaw 106 may not exceed the length L of the extended rod 102.

It is contemplated that the elongated rod 102 may comprise an external thread. The external thread may cover the entire length L of the elongated rod 102, but it is contemplated that the external thread may cover any amount and any portion of the elongated rod 102. For instance, in an exemplary embodiment, the external thread may begin at the distal end of the elongated rod 102 and may continue until a halfway point (i.e., one-half length L) of the elongated rod 102. The distal end may be defined as the end of the elongated rod 102 opposite of the fixed jaw 104 attachment.

It is contemplated that the aperture 107 may comprise an internal thread to complement an external thread of the elongated rod 102.

As seen in FIGS. 1A and 3, the end piece 108 comprises a bore 126. The bore 126 may fully extend through the end piece 108. The bore 126 may complement the cross-sectional shape of the elongated rod 102, such that the elongated rod 102 may be receivable through the bore 126 and the end piece may be movable along axis Lx of the elongated rod 102. The end piece 108 may be configured to maintain the position the movable jaw 106 along axis Lx of the elongated rod 102 such that the movable jaw 106 may no longer be moved freely, inwardly, and outwardly along axis Lx of the elongated rod 102.

The end piece 108 may contain a means for securing the end piece 108 to the elongated rod 102, said securing means comprising a shaft collar, a spring collar, or a pin. The securing means may be configured to fix the position of both the end piece 108 and the movable jaw 106 along axis Lx of the elongated rod 102.

The end piece 108 may alternatively comprise an internal thread within the bore 128 to complement an external thread of the elongated rod 102, such that a clockwise rotation of the end piece 108 will cause the end piece 108 to move along axis Lx of the elongate rod 102 and into presumed engagement with the movable jaw 106. In this embodiment, it is contemplated that the end piece 108, assisted by its internal threads and the external threads of the elongated rod 102, may maintain a fixed position along axis Lx of the elongated rod 102. In this threaded embodiment, it is contemplated that the position of the end piece 108 may only be altered if the end piece 108 is acted upon by outside forces, namely a counterclockwise rotation of the end piece 108.

The end piece 108 may comprise a handle 128. The handle 128 may be used by a user to more easily move the end piece 108. The handle 128 may be in the form of any shape, and it is contemplated that the handle 128 may form an ergonomic shape designed to fit comfortably within a user's hands and/or fingers.

As seen in FIG. 1C, it is contemplated that the elongated rod 102, the fixed jaw 104, and the movable jaw 106 may form or substantially form the perimeter of an engagement area A. The engagement area A may be configured to complement the size and/or shape of the object(s) to be restrained and/or stowed.

In an exemplary method of use of the device, the elongated rod 102 and the fixed jaw 104 are first positioned so as to bring the object(s) to be restrained/stowed in contact with the engagement surface 114 of the first portion 110 of the fixed jaw 104 and the engagement surface 116 of the second portion 112 of the fixed jaw 104. The object(s) may further be in contact with the elongated rod 102 or may alternatively be in close proximity to the elongated rod 102.

In an exemplary method of use, the movable jaw 106 is positioned so as to place the elongated rod 102 through the aperture 107 of the movable jaw 106. The movable jaw 106 is further positioned so as to bring the object(s) to be restrained/stowed in contact with the engagement surface 122 of the first portion 118 of the movable jaw 106 and the engagement surface 124 of the second portion 120 of the movable jaw 106.

In an exemplary method of use, the end piece 108 is positioned so as to place the elongated rod 102 through the bore 126 of the end piece 108. The end piece 108 is further positioned so as to direct the movable jaw 106 toward secure engagement with the object(s) to be restrained/stowed by fixing the position of the movable jaw 106 along the elongated rod 102 and restricting further movement of the movable jaw 106. In one embodiment, as noted above, wherein the elongated rod 102 comprises an external thread and the bore 126 comprises complimentary internal threads, a user may rotate the end piece 108 in a clockwise manner to actuate movement of the end piece 108 towards the movable jaw 106 and into presumed engagement with the movable jaw 106 and the object(s).

It should be understood that modifications to the embodiments disclosed herein can be made to meet a particular set of design criteria. For instance, the number of or configuration of components or parameters may be used to meet a particular objective.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

1-3. (canceled)

4. The restraint and stowage device of claim 14, wherein the elongated rod has an external thread.

5. The restraint and stowage device of claim 4, wherein the bore has an internal thread and wherein the internal thread is configured to complement the external thread of the elongated rod.

6. The restraint and stowage device of claim 4, wherein the aperture has an internal thread, wherein the internal thread is configured to complement the external thread of the elongated rod.

7. The restraint and stowage device of claim 14, wherein the end piece comprises a securing means.

8. The restraint and stowage device of claim 14, wherein the end piece comprises a handle.

9. The restraint and stowage device of claim 14, wherein the elongated rod and the fixed jaw are a single molded piece.

10. (canceled)

11. The restraint and stowage device of claim 14, wherein the first portion of the fixed jaw and the second portion of the fixed jaw form an elbow.

12. (canceled)

13. The restraint and stowage device of claim 14, wherein the first portion of the movable jaw and the second portion of the movable jaw form an elbow.

14. A restraint and stowage device, comprising:
an L-shaped fixed jaw comprising a first portion and a second portion, wherein the first portion of the fixed jaw and the second portion of the fixed jaw are configured to jointly engage an object to be restrained;
an elongated rod attached to the first portion of the fixed jaw, wherein the elongated rod extends in the same direction as the second portion of the fixed jaw;
an L-shaped movable jaw comprising a first portion and a second portion, wherein the first portion of the movable jaw and the second portion of the movable jaw are configured to jointly engage an object to be restrained;
an aperture positioned within the first portion of the movable jaw, wherein the elongated rod is receivable through the aperture and wherein the movable jaw is configured to move about the elongated rod; and
an end piece comprising a bore, wherein the elongated rod is receivable through the bore and wherein the end piece is configured to maintain a position of the movable jaw,
wherein the elongated rod, the first and second portions of the fixed jaw, and the first and second portions of the movable jaw substantially form the perimeter of an engagement area.

15. A method of using the restraint and stowage device of claim 14, comprising:
positioning the fixed jaw and the elongated rod such that an object is contacted by the fixed jaw;
receiving the elongated rod through the aperture of the movable jaw;
positioning the movable jaw such that the object is contacted by the movable jaw;
receiving the elongated rod through the bore of the end piece; and
positioning the end piece in contact with the movable jaw.

16. The method of claim 15, further comprising:
fixing the position of the end piece such that the position of the movable jaw is maintained.

17. The method of claim 15, wherein the elongated rod has an external thread and the bore has an internal thread configured to complement the external thread of the elongated rod, further comprising:
fixing the position of the end piece such that the position of the movable jaw is maintained by rotating the end piece.

18. The restraint and stowage device of claim 14, wherein the first portion of the fixed jaw has a flat engagement surface configured to engage the object to be restrained and the second portion of the fixed jaw has a flat engagement surface configured to engage the object to be restrained.

19. The restraint and stowage device of claim 14, wherein the first portion of the movable jaw has a flat engagement surface configured to engage the object to be restrained and the second portion of the movable jaw has a flat engagement surface configured to engage the object to be restrained.

20. The restraint and stowage device of claim 14, wherein the elongated rod and the second portion of the fixed jaw are parallel.

21. The restraint and stowage device of claim 7, wherein the securing means is selected from the group consisting of a shaft collar, a spring collar, and a pin.

22. The restraint and stowage device of claim 14, wherein the elongated rod, the first and second portions of the fixed jaw, and the first and second portions of the movable jaw form the perimeter of the engagement area.
